(19) United States
(12) Patent Application Publication
(10) Pub. No.: US 2023/0354072 A1
(43) Pub. Date: Nov. 2, 2023

(54) DL MEASUREMENT INFORMATION SIGNALING FOR IMPROVED DL TRANSMISSIONS

(71) Applicant: HUAWEI TECHNOLOGIES CO., LTD., Shenzhen (CN)

(72) Inventors: Majid NASIRI KHORMUJI, Kista (SE); Yi QIN, Shanghai (CN)

(21) Appl. No.: 18/338,951

(22) Filed: Jun. 21, 2023

Related U.S. Application Data
(63) Continuation of application No. PCT/EP2021/054630, filed on Feb. 25, 2021.

(51) Int. Cl. H04W 24/08; H04L 5/00

(52) U.S. Cl. CPC H04W 24/08; H04L 5/0048

(57) ABSTRACT

A client device and a network access node engaged in downlink measurement information signaling and transmission in a communication system. The client device transmits a set of uplink reference signals and a feedback signal to the network access node. The feedback signal indicates measurement information about the downlink between the client device and a network access node. Based on the set of uplink reference signals and the feedback signal, the network access node determines a precoder and performs a downlink transmission of data/pilots to the client device using the precoder.

### CROSS-REFERENCE TO RELATED APPLICATIONS

This application is a continuation of International Application No. PCT/EP2021/054630, filed on Feb. 25, 2021, the disclosure of which is hereby incorporated by reference in its entirety.

### BACKGROUND

Downlink (DL) precoding in 3GPP Fifth Generation (5G) particularly for large scale arrays is based on uplink (UL) Sounding Reference Signal (SRS) transmission from a User Equipment (UE) to a gNB, a.k.a. Base Station (BS), in the Time-Division Duplex (TDD). That is, the UE transmits SRS and the gNB based on the received SRS estimates the corresponding UL channel. Then, the gNB by assuming perfect reciprocity under the TDD protocol constructs the associated DL channel based on the measured UL channel. The gNB finally forms or selects a precoder, e.g., based on singular value decomposition (SVD) of the correlation matrix of measured UL channel, for precoding of modulated and coded DL data or control signals.

In practical TDD transmission, the complete Uplink-Downlink (UL-DL) reciprocity does not hold. That is, the UL and DL channels are not exactly the same even in response to the UL and DL channels operating over the same frequency. This results in a mismatched UL-DL reciprocity, a.k.a. non-ideal or incomplete reciprocity, which in turn causes a notable loss in the throughput since the selected DL precoder is chosen according to an UL channel which is mismatched to the actual DL channel. The current TDD solution in 5G standard does not account for the existence of the incomplete reciprocity issue. This therefore causes a notable degradation in the performance.

### SUMMARY

An objective of at least one embodiment is to provide a solution which mitigates or solves the drawbacks and problems of conventional solutions.

Another objective of at least one embodiment is to provide a solution with improved DL transmission performance compared to conventional solutions.

The above and further objectives are solved by the subject matter of the independent claims. Further advantageous of at least one embodiment is found in the dependent claims.

According to a first aspect of at least one embodiment, the above mentioned and other objectives are achieved with a client device for a wireless communication system, the client device being configured to
receive a set of downlink reference signals from a network access node;
determine downlink measurement information for a set of antenna ports of the client device based on the set of received downlink reference signals;
determine a feedback signal indicating the downlink measurement information;
transmit a set of uplink reference signals to the network access node via the set of antenna ports of the client device; and
transmit the feedback signal to the network access node.

Examples of embodiments described herein are not limited to the specific order given above. Hence, the reception, determination, and transmission are performed in another order as long as the technical effect provided hereby remains.

Further, the mentioned set of antenna ports of the client device in some standards are denoted transmission (Tx) antenna ports.

An advantage of the client device according to the first aspect is that the network access node is able to account for incomplete reciprocity in TDD by using both the received UL reference signals and the feedback signal from the client device. By doing this, the network access node obtains an improved estimate of the actual downlink channel by which the network access node selects or configure an enhanced DL precoder. This will therefore improve the quality of the service and in particular the DL spectral efficiency.

In an implementation form of a client device according to the first aspect, determining the downlink measurement information for the set of antenna ports of the client device comprises:
determine downlink measurement information for each subset of antenna ports in the set of antenna ports of the client device, wherein each subset of antenna ports comprises at least one antenna port.

An advantage with this implementation form is that the measurements are grouped for different subsets of the antenna ports such that the subset of the antenna ports are formed in response to the relation between UL and DL mismatch properties of antenna ports in the same subset being known or being assumed as known at the network access node. For example, the antenna ports in the same subset are assumed to have the same UL-DL mismatch property.

In an implementation form of a client device according to the first aspect, the set of antenna ports of the client device are grouped into subsets of antenna ports based on at least one of
an antenna switching pattern of the set of antenna ports of the client device associated with the transmission of the uplink reference signals; and
mismatch properties between different antenna ports in the set of antenna ports.

Uplink reference signals transmitted on antenna ports on different uplink reference signal resources have the same antenna port index. This case is also considered as that the measurement information is for each uplink reference signal resource within the uplink reference signal resource set for antenna switching.

Further, correlation is one of the properties of the mismatch that is used as one method for such grouping.

Mismatch properties are not limited to receiver (Rx) and transmitter (Tx) hardware mismatch, and Specific Absorption Ratio (SAR) control at the client device.

An advantage with this implementation form is that the UL transmitted reference signals enable an enhanced estimate of the UL channel and reduce the reference signal overhead.

In an implementation form of a client device according to the first aspect, determining the downlink measurement information for the set of antenna ports of the client device comprises:
determine downlink measurement information for each downlink frequency band carrying the set of downlink reference signals.

An advantage with this implementation form is that the solution is used with multicarrier waveform, such as orthogonal frequency division multiplexing (OFDM). The DL frequency band is determined based on the bandwidth of the mismatch coherence; i.e. the bandwidth over which the mismatch properties remains virtually unchanged. In this way the overhead in the frequency domain is reduced to the bandwidth of the mismatch coherence.

In an implementation form of a client device according to the first aspect, the downlink measurement information indicates second order statistics of a downlink channel estimation, and wherein the second order statistics of the downlink channel estimation comprises at least one of:
a downlink channel correlation matrix,
a squared Euclidean norm of the downlink channel estimation, and
a squared Euclidean norm of the downlink channel estimation scaled with a scaling factor.

An advantage with this implementation form is that the feedback overhead is reduced notably as the feedback relies on the second order statistics instead of individual channel realization whose reporting will require a much larger overhead. At the same time, the feedback allows to correct the UL and DL mismatch.

In an implementation form of a client device according to the first aspect, the downlink measurement information indicates a downlink received power at the set of antenna ports of the client device.

The downlink received power is e.g. reference signal received power or any other suitable power measure.

An advantage with this implementation form is that the implementation allows to significantly reduce the feedback overhead and simultaneously enables correction of the UL and DL mismatch.

In an implementation form of a client device according to the first aspect, the feedback signal indicates the downlink measurement information as:
an incremental change of downlink measurement information compared to previous downlink measurement information; or
an incremental change of downlink measurement information for different antenna ports or subsets of antenna ports compared to other antenna ports or other subsets of antenna ports.

An advantage with this implementation form is that to further reduce the feedback overhead.

In an implementation form of a client device according to the first aspect, the feedback signal is a digital feedback signal obtained based on an uniform or a non-uniform quantizer, wherein a quantization region or a corresponding mapping of the uniform or the non-uniform quantizer is configured based on at least one of:
specific absorption ratio control, and
hardware mismatch properties between different antenna ports of the set of antenna ports of the client device.

An advantage with this implementation form is that the quantized feedback better represents the un-quantized feedback with lower distortion by designing the quantizer based on the properties of the specific absorption ratio control and hardware mismatch. That is, for example the quantization region and mapping are obtained based on the statistical properties of mismatch.

According to a second aspect of at least one embodiment, the above mentioned and other objectives are achieved with a network access node for a wireless communication system, the network access node being configured to
transmit a set of downlink reference signals to a client device;
receive a set of uplink reference signals from the client device;
receive a feedback signal from the client device, wherein the feedback signal indicates downlink measurement information for a set of antenna ports of the client device associated with the set of downlink reference signals.

An advantage of the network access node according to the second aspect is that the network access node enables correction of the UL and DL mismatch such that the network access node obtains an estimate of the DL channel which matches the actual DL channel.

In an implementation form of a network access node according to the second aspect, the determining of the precoder comprises:
compute a correlation matrix based on the set of received uplink reference signals and the received feedback signal,
determine a precoder for the downlink transmission to the client device based on the computed correlation matrix, and
perform a downlink transmission to the client device based on the precoder.

An advantage with this implementation form is that the precoder is designed based on the both feedback and UL reference signals which enables to correct the UL-DL mismatch. That is, the precoder is designed for actual DL channel by taking into account the mismatch. This in turns improves the quality of service, e.g. spectral efficiency, throughput, block or bit error rate, delivered to the client device.

In an implementation form of a network access node according to the second aspect, the feedback signal indicates downlink measurement information for each subset of antenna ports in the set of antenna ports of the client device, wherein each subset of antenna ports comprises at least one antenna port.

An advantage with this implementation form is that the measurements are grouped for different subsets of the antenna ports such that the subset of the antenna ports are formed in response to the relation between UL and DL mismatch properties of antenna ports in the same subset being known or being assumed as known at the network access node. For example, the antenna ports in the same subset are assumed to have the same UL-DL mismatch property.

In an implementation form of a network access node according to the second aspect, the feedback signal indicates downlink measurement information for each downlink frequency band carrying the set of downlink reference signals.

An advantage with this implementation form is that the solution is used with multicarrier waveform, such as OFDM. The DL frequency band is determined based on the bandwidth of the mismatch coherence; i.e. the bandwidth over which the mismatch properties remains virtually unchanged. In this way the overhead in the frequency domain is reduced to the bandwidth of the mismatch coherence.

In an implementation form of a network access node according to the second aspect, the downlink measurement information indicates second order statistics of a downlink channel estimation, and wherein the second order statistics of the downlink channel estimation comprises at least one of:
a downlink channel correlation matrix,
a squared Euclidean norm of the downlink channel estimation, and
a squared Euclidean norm of the downlink channel estimation scaled with a scaling factor.

An advantage with this implementation form is that reduces the feedback overhead is reduced notably as the feedback relies on the second order statistics instead of individual channel realization whose reporting will require a much larger overhead. At the same time, feedback allows correction of the UL and DL mismatch.

In an implementation form of a network access node according to the second aspect, the downlink measurement information indicates a downlink received power at the set of antenna ports of the client device.

An advantage with this implementation form is that the implementation allows significantly reduction of the feedback overhead and simultaneously enables correction of the UL and DL mismatch.

In an implementation form of a network access node according to the second aspect, the feedback signal indicates the downlink measurement information as:
an incremental change of downlink measurement information compared to previous downlink measurement information; or
an incremental change of downlink measurement information for different antenna ports or subsets of antenna ports compared to other antenna ports or other subsets of antenna ports.

An advantage with this implementation form is that to further reduce the feedback overhead.

In an implementation form of a network access node according to the second aspect, the feedback signal is a digital feedback signal obtained based on an uniform or a non-uniform quantizer, wherein a quantization region or a corresponding mapping of the uniform or the non-uniform quantizer is configured based on at least one of:
specific absorption ratio control, and
hardware mismatch properties between different antenna ports of the set of antenna ports of the client device.

An advantage with this implementation form is that the quantized feedback better represents the un-quantized feedback with lower distortion by designing the quantizer based on the properties of the specific absorption ratio control and hardware mismatch. That is, for example the quantization region and mapping are obtained based on the statistical properties of mismatch.

According to a third aspect of at least one embodiment, the above mentioned and other objectives are achieved with a method for a client device, the method comprises
receiving a set of downlink reference signals from a network access node;
determining downlink measurement information for a set of antenna ports of the client device based on the set of received downlink reference signals;
determining a feedback signal indicating the downlink measurement information;
transmitting a set of uplink reference signals to the network access node via the set of antenna ports of the client device; and
transmitting the feedback signal to the network access node.

The method according to the third aspect is extended into implementation forms corresponding to the implementation forms of the client device according to the first aspect. Hence, an implementation form of the method comprises the feature(s) of the corresponding implementation form of the client device.

The advantages of the methods according to the third aspect are the same as those for the corresponding implementation forms of the client device according to the first aspect.

According to a fourth aspect of at least one embodiment, the above mentioned and other objectives are achieved with a method for a network access node, the method comprises
transmitting a set of downlink reference signals to a client device;
receiving a set of uplink reference signals from the client device;
receiving a feedback signal from the client device, wherein the feedback signal indicates downlink measurement information for a set of antenna ports of the client device associated with the set of downlink reference signals.

The method according to the fourth aspect is extended into implementation forms corresponding to the implementation forms of the network access node according to the second aspect. Hence, an implementation form of the method comprises the feature(s) of the corresponding implementation form of the network access node.

The advantages of the methods according to the fourth aspect are the same as those for the corresponding implementation forms of the network access node according to the second aspect.

Examples described herein also relate to a computer program, characterized in program code, which in response to being run by at least one processor causes said at least one processor to execute any method according to embodiments described herein. Further, examples of embodiments described also related to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the examples of embodiments described herein are apparent from the following detailed description.

### BRIEF DESCRIPTION OF THE DRAWINGS

The appended drawings are intended to clarify and explain different examples of embodiments described herein, in which:

FIG. 1 shows a client device according to at least one embodiment;

FIG. 2 shows a method for a client device according to at least one embodiment;

FIG. 3 shows a network access node according to at least one embodiment;

FIG. 4 shows a method for a network access node according to at least one embodiment;

FIG. 5 illustrates a wireless communication system according to at least one embodiment;

FIG. 6 shows a mobile device according to at least one embodiment;

FIG. 7 illustrates signaling between a gNB and a UE according to at least one embodiment;

FIG. 8 shows a flow chart according to at least one embodiment; and

FIG. 9 shows performance results for examples of the invention.

### DETAILED DESCRIPTION

The incomplete reciprocity between UL and DL channels aforementioned is explained by two reasons, i.e. a receiver (Rx) and transmitter (Rx) hardware mismatch, and Specific Absorption Ratio (SAR) control at the UE.

One of the reasons that the practical radio channel is not reciprocal is due to the hardware mismatch since the actual radio channel does not only consist of the space radio channel, but also components such as the physical antennas, Radio Frequency (RF) mixers, filters, Analog-to-Digital (A/D), Digital-to-Analog (D/A) converters and other related electronic devices. That is, where the channel measurements is conducted is crucial. Therefore, in response to the measurement paths for the UL and DL channels not going through exactly the same steps, which normally is not the case due to the non-ideality of the components and hardware mismatch, the complete reciprocity does not hold. That is, unequal measured values associated to UL and DL channels are seen even in the TDD protocol in which the UL and DL transmissions are over the same frequency bands.

The gNB is calibrated based on its circuitry and not the circuitry at the UE such that the gNB has control on its input-output signals. On the other hand, the circuitry at the UE is variable as the UE pools are large and diverse and the gNB cannot calibrate to any arbitrary UE. Nevertheless, the gNB has no mechanism in place to find the mismatch due to the circuitry at the UE. The mismatch is hence considered for the circuitry at the UE. Moreover, the gNB cannot assume that all UEs have their own hardware mismatch detection. Thus, the hardware mismatch is assumed to be unknown at the UE in response to designing the wireless communication links.

Further, there are regulations from individual governments regarding human exposure to radio frequency (RF) electromagnetic fields (EMF). In particular, a UE should comply with the SAR limit issued by the government of the country. There are normally some SAR test scenarios prescribed to measure and evaluate the SAR value. One example scenario is in response to the UE being located close to the ear. The measured SAR value should be below a target value, i.e. limit, given by local regulations to confine the effects of radiation to ensure the users' health.

SAR is measured in W/kg, which indicates power absorbed by unit mass. The following two equations gives definitions for SAR measurement:

$$SAR = \frac{d}{d t} ( \frac{d W}{d m} ) = \frac{d}{d t} ( \frac{dW}{ρ d V} ) \qquad ( 1 )$$

where W denotes the electromagnetic energy, m is the mass, V is the volume, and p denotes the density. This equation describes the incremental electromagnetic power absorbed by an incremental mass contained in a volume element of given density, averaged over a certain period of time. Another equivalent definition to Eq. (1), is given by

$${SAR = \frac{c Δ T}{Δ t} \vert}_{t = 0} \qquad ( 2 )$$

where c denotes the specific heat capacity, i.e. the amount of heat supplied to or taken out of the unit mass of a system in order to increase (or decrease) its temperature by one degree, ΔT denotes the temperature variation and Δt is the duration of times of exposure. The second definition is the equivalent based on the change in the temperature and specific heat constant.

The measured SAR value according to Eq. (1) or (2) is controlled at the UE to make sure that the measured SAR is below the target value. In response to the UE performing SAR control, the UE activates a procedure that implements a power mask such that the energy of the transmitted electromagnetic wave is confined in a desirable manner. One popular control action is that the UE reduces its maximum power. The control action is modelled by power reduction factor at the UE. This power reduction causes a mismatch between the UL and DL channels since the power reduction is only present on the UL channel and does not affect the DL channel.

The hardware mismatch is modelled as power reduction and phase rotation on the signal that is transmitted from each UE antenna, and SAR control is modelled as power reduction on the signal to be transmitted from each UE's antenna without any phase rotation. That is, in response to Sᵣ being the uplink signal that UE wants to transmit on antenna r, after the above causes, the transmitted signal on this antenna is written as Sᵣ^{mis}=αᵣβᵣe^{jθ}^{ᵣ}Sᵣ, where the parameters αᵣ, βᵣ and θᵣ respectively denote power reduction factor of hardware mismatch, power reduction factor of SAR control and phase rotation of hardware mismatch for antenna r. The range of the parameters are given as αᵣ, βᵣ ∈(0,1], θᵣ∈[−π, π]. This linear model is used to exemplify the present solution and its performance advantages. That is, the present solution is not limited to this linear model of the mismatch and is tuned to other models of mismatch.

An objective in this disclosure is to introduce a solution for compensating the adverse effects of incomplete UL-DL reciprocity for DL MIMO precoding due to the mismatched DL and UL channel measurements that stems from different circuitry used at the UE and gNB as well as implementation of SAR operation for limiting electromagnetic radiation from the UE.

Examples of embodiments described herein therefore disclose an enhanced DL MIMO precoding method for the TDD-based systems by employing an efficient feedback signaling mechanism from the UE to gNB with low overhead such that the gNB is able to compute a DL precoder as the GNB had accessed the actual DL channel without no UL-DL mismatch. The feedback signal is e.g. construed based on the reception of specially designed sparse DL pilots to probe the state of mismatch, which is referred to as mismatch state information reference signal (MSI-RS). Schemes with both analog and digital feedback strategies are further provided. The feedback signal is used to construct the correlation matrix of the DL channel as there were no mismatch, by which the DL precoder is constructed for precoding of DL data and pilots. Further examples and aspects of the present solution will be presented in the following disclosure.

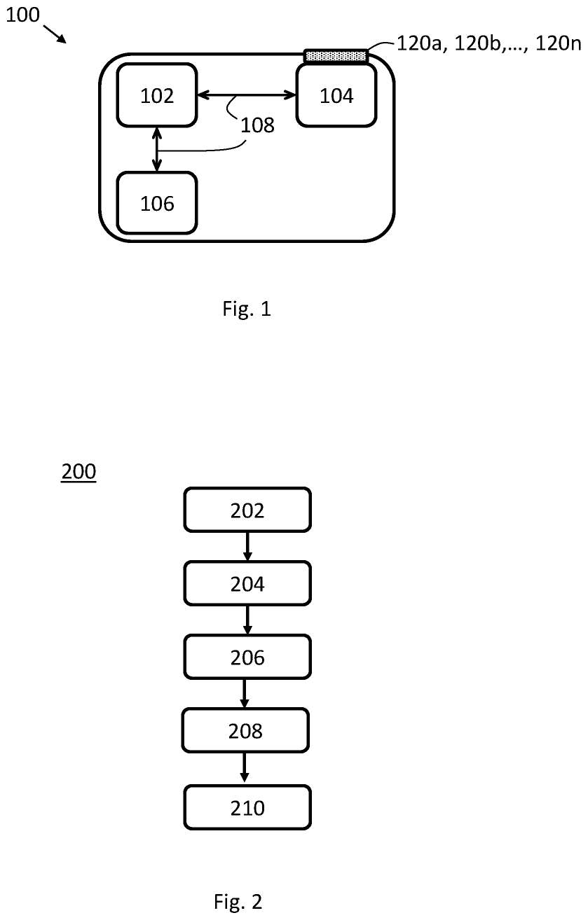

FIG. 1 shows a client device 100 according to at least one embodiment. In the example shown in FIG. 1, the client device 100 comprises a processor 102, a transceiver 104 and a memory 106. The processor 102 is coupled to the transceiver 104 and the memory 106 by communication means 108 known in the art. The client device 100 further includes an antenna or antenna array 110 coupled to the transceiver 104, which means that the client device 100 is configured for wireless communications in a wireless communication system. That is, the client device 100 is configured to perform certain actions in this disclosure is understood to mean that the client device 100 comprises suitable means, such as e.g. the processor 102 and the transceiver 104, configured to perform said actions.

The client device 100 in this disclosure includes but is not limited to: a UE such as a smart phone, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, an in-vehicle device, a wearable device, an integrated access and backhaul node (IAB) such as mobile car or equipment installed in a car, a drone, a device-to-device (D2D) device, a wireless camera, a mobile station, an access terminal, an user unit, a wireless communication device, a station of wireless local access network (WLAN), a wireless enabled tablet computer, a laptop-embedded equipment, an universal serial bus (USB) dongle, a wireless customer-premises equipment (CPE), and/or a chipset. In an Internet of things (IOT) scenario, the client device 100 represents a machine or another device or chipset which performs communication with another wireless device and/or a network equipment.

The UE is further referred to as a mobile telephone, a cellular telephone, a computer tablet or laptop with wireless capability. The UE in this context is e.g. a portable, pocket-storable, hand-held, computer-comprised, or vehicle-mounted mobile device, enabled to communicate voice and/or data, via the radio access network, with another entity, such as another receiver or a server. The UE is a station (STA), which is any device that contains an IEEE 802.11-conformant media access control (MAC) and physical layer (PHY) interface to the wireless medium (WM). The UE is also configured for communication in 3GPP related LTE and LTE-Advanced, in WiMAX and its evolution, and in fifth generation wireless technologies, such as NR.

The processor 102 of the client device 100 is referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, and one or more chipsets. The memory 106 of the client device 100 is a read-only memory, a random access memory, or a non-volatile random access memory (NVRAM). The transceiver 104 of the client device 100 is a transceiver circuit, a power controller, an antenna, or an interface which communicates with other modules or devices. In examples, the transceiver 104 of the client device 100 is a separate chipset or being integrated with the processor 102 in one chipset. While in some examples, the processor 102, the transceiver 104, and the memory 106 of the client device 100 are integrated in one chipset.

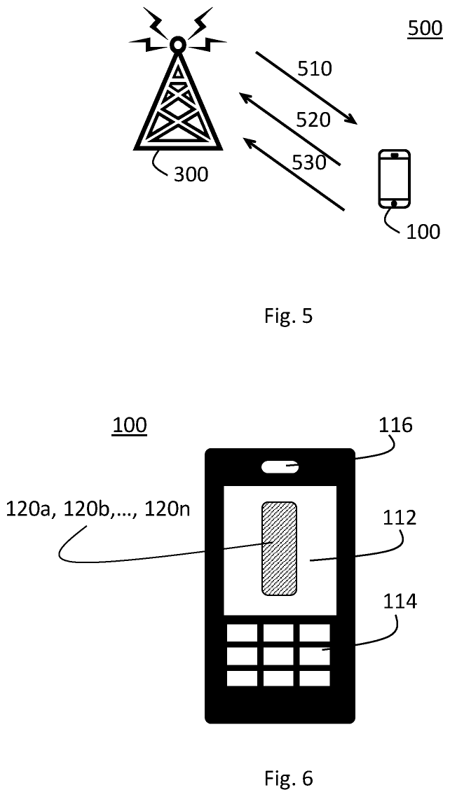

With reference to FIGS. 1 and 5, in examples of embodiments described herein the client device 100 is configured to receive a set of downlink reference signals 510 from a network access node 300. The client device 100 is configured to determine downlink measurement information for a set of antenna ports 120a, 120b, . . . , 120n of the client device 100 based on the set of received downlink reference signals 510. The client device 100 is configured to determine a feedback signal indicating the downlink measurement information. The client device 100 is configured to transmit a set of uplink reference signals 520 to the network access node 300 via the set of antenna ports 120a, 120b, . . . , 120n of the client device 100. The client device 100 is configured to transmit the feedback signal 530 to the network access node 300.

The antenna ports 120a, 120b, . . . , 120n are antenna ports of uplink reference signals 520:
In one non-limiting example, each antenna port of the set of antenna ports 120a, 120b, . . . , 120n has an antenna port index different from other antenna ports in the set of antenna ports 120a, 120b, . . . , 120n, e.g., in response to there being 4 antenna ports in the set, their indexes are #0, #1, #2 and #3.
In another non-limiting example, some antenna ports in the set of antenna ports 120a, 120b, . . . , 120n have the same antenna port index. In this case, the antenna ports belong to multiple uplink reference signal resources and the antenna port indexes are reused in these uplink reference signal resources. For example, there are 4 antenna ports in the set, and each two of them belong to one uplink reference signal resource, and thus there are two uplink reference signal resources. These two uplink reference signal resources belong to one uplink reference signal resource set, and the usage of this resource set is “antenna switching” or “DL CSI acquisition”. In this case, the antenna port indexes of the antenna ports in the first uplink reference signal resource are #0 and #1,and the antenna port indexes of the antenna ports in the second uplink reference signal resource are also #0 and #1.

That the downlink measurement information is determined for a set of antenna ports 120a, 120b, . . . , 120n means that the downlink measurement information is determined based on the received downlink reference signals 510 on the receiving antennas corresponding to (or the same as) the transmitting antennas of the set of antenna ports 120a, 120b, . . . , 120n. The transmitting antennas are the physical antennas, virtual antennas, UE ports, UE antenna ports, etc.

FIG. 2 shows a flow chart of a corresponding method 200 which is executed in a client device 100, such as the one shown in FIG. 1. The method 200 comprises receiving 202 a set of downlink reference signals 510 from a network access node 300. The method 200 comprises determining 204 downlink measurement information for a set of antenna ports 120a, 120b, . . . , 120n of the client device 100 based on the set of received downlink reference signals 510. The method 200 comprises determining 206 a feedback signal indicating the downlink measurement information. The method 200 comprises transmitting 208 a set of uplink reference signals 520 to the network access node 300 via the set of antenna ports 120a, 120b, . . . , 120n of the client device 100. The method 200 comprises transmitting 210 the feedback signal 530 to the network access node 300.

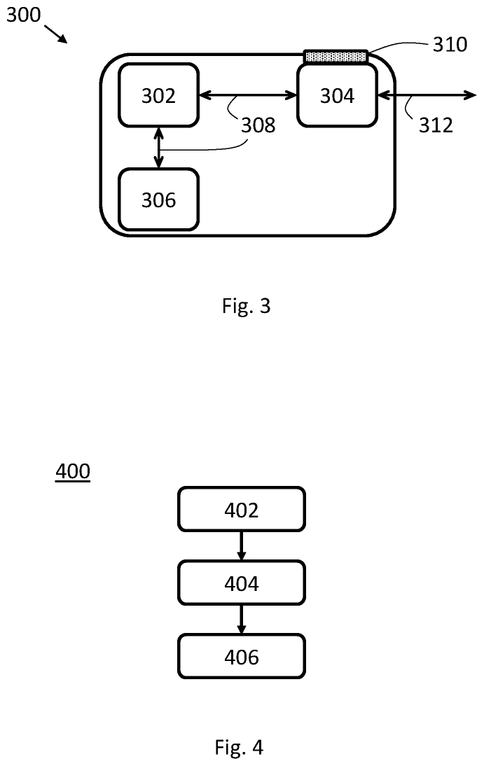

FIG. 3 shows a network access node 300 according to at least one embodiment. In the example shown in FIG. 3, the network access node 300 comprises a processor 302, a transceiver 304 and a memory 306. The processor 302 is coupled to the transceiver 304 and the memory 306 by communication means 308 known in the art. The network access node 300 is configured for both wireless and wired communications in wireless and wired communication systems, respectively. The wireless communication capability is provided with an antenna or antenna array 310 coupled to the transceiver 304, while the wired communication capability is provided with a wired communication interface 312 coupled to the transceiver 304. That the network access node 300 is configured to perform certain actions in this disclosure is understood to mean that the network access node 300 comprises suitable means, such as e.g. the processor 302 and the transceiver 304, configured to perform said actions.

The network access node 300 in this disclosure includes but is not limited to: a NodeB in wideband code division multiple access (WCDMA) system, an evolutional Node B (eNB) or an evolved NodeB (eNodeB) in LTE systems, or a relay node or an access point, or an in-vehicle device, a wearable device, or a gNB in the fifth generation (5G) networks. Further, the network access node 300 herein is denoted as a radio network access node, an access network access node, an access point, or a base station, e.g. a radio base station (RBS), which in some networks are referred to as transmitter, “gNB”, “gNodeB”, “eNB”, “eNodeB”, “NodeB” or “B node”, depending on the technology and terminology used. The radio network access nodes are of different classes such as e.g. macro eNodeB, home eNodeB or pico base station, based on transmission power and thereby also cell size. The radio network access node is a station (STA), which is any device that contains an IEEE 802.11-conformant MAC and PHY interface to the wireless medium. The radio network access node is also a base station corresponding to the 5G wireless systems.

The processor 302 of the network access node 300 is referred to as one or more general-purpose CPUs, one or more DSPs, one or more ASICs, one or more FPGAs, one or more programmable logic devices, one or more discrete gates, one or more transistor logic devices, one or more discrete hardware components, and one or more chipsets. The memory 306 of the network access node 300 is a read-only memory, a random access memory, or a NVRAM. The transceiver 304 of the network access node 300 is a transceiver circuit, a power controller, an antenna, or an interface which communicates with other modules or devices. In examples, the transceiver 304 of the network access node 300 is a separate chipset or being integrated with the processor 302 in one chipset. While in some examples, the processor 302, the transceiver 304, and the memory 306 of the network access node 300 are integrated in one chipset.

With reference to FIGS. 3 and 5, in examples of embodiments described herein the network access node 300 is configured to transmit a set of downlink reference signals 510 to a client device 100. The network access node 300 is configured to receive a set of uplink reference signals 520 from the client device 100. The network access node 300 is configured to receive a feedback signal 530 from the client device 100, wherein the feedback signal 530 indicates downlink measurement information for a set of antenna ports 120a, 120b, . . . , 120n of the client device 100 associated with the set of downlink reference signals 510.

FIG. 4 shows a flow chart of a corresponding method 400 which is executed in a network access node 300, such as the one shown in FIG. 3. The method 400 comprises transmitting 402 a set of downlink reference signals 510 to a client device 100. The method 400 comprises receiving 404 a set of uplink reference signals 520 from the client device 100. The method 400 comprises receiving 406 a feedback signal 530 from the client device 100, wherein the feedback signal 530 indicates downlink measurement information for a set of antenna ports 120a, 120b, . . . , 120n of the client device 100 associated with the set of downlink reference signals 510.

FIG. 5 shows a communication system 500 according to at least one embodiment. The communication system 500 comprises a client device 100 and a network access node 300 configured to operate in the wireless communication system 500. For simplicity, the communication system 500 shown in FIG. 5 only comprises one client device 100 and one network access node 300. However, the communication system 500 includes any number of client devices 100 and any number of network access nodes 300 without deviating from the scope of embodiments described herein.

In the communication system 500, a DL transmission is performed from the network access node 300 to the client device 100 and a UL transmission in the reverse direction, i.e. from the client device 100 to the network access node 300. FIG. 5 illustrates that the network access node 300 is configured to transmit DL reference signals 510 to the client device 100. FIG. 5 further illustrates that the client device is configured to transmit UL reference signals 520 and feedback signals 530 to the network access node 300. The network access node 300 is configured to transmit either beamformed transmission or/and multilayer transmission to the client device 100 using a precoder or selecting a precoder from a set of codebooks which is defined in standards.

FIG. 6 illustrates a non-limiting example of a client device 100 in the form of a mobile device. The mobile device houses at least one processor 102 (see e.g. FIG. 1), at least one display device 112, and at least one communications means (not shown in FIG. 6). The mobile device further comprises input means e.g. in the form of a keyboard 114 communicatively connected to the display device 112. The mobile device further comprises output means e.g. in the form of a speaker 116. As illustrated in FIG. 6 the mobile device also comprises a set of antenna ports 120a, 120b, . . . , 120n. The mobile device is a mobile phone, a tablet PC, a mobile PC, a smart phone, a standalone mobile device, or any other suitable communication device.

Further examples and aspect of embodiments described herein are presented. For providing deeper understanding of the present solution and to illustrate implementation cases the following examples herein given are set in a 3GPP 5G context hence the terminology and system architecture used. Therefore, a client device 100 is denoted a UE and a network access node 300 a gNB.

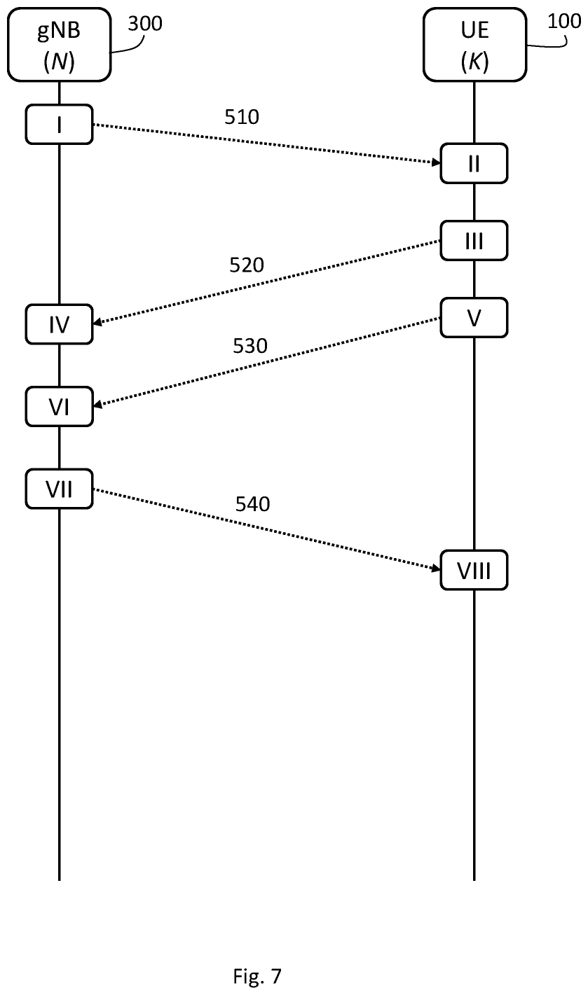

With reference to FIG. 7, a transmission link is assumed between a gNB that includes N number of transmit antenna ports and a UE comprising K number of antenna ports. An example of the general disclosed solution in details is next introduced by describing the associated signaling and exchanges of control messages between the gNB and UE.

### Step I in FIG. 7

A gNB transmits a set of DL sparse pilot signals (a.k.a. reference signals) 510 in the time-frequency plane to a UE in Step I. The DL pilot signals might be chosen from a set of mutually orthogonal sequences mapped to time-frequency plane using code-division multiplexing (CDM), frequency-division multiplexing (FDM) or time-division multiplexing (TDM). At least one embodiment relies on a designated pilot design for this purpose. In one implementation, the gNB uses a new type of pilots previously referred to as MSI-RS, by help of which the state of the mismatch is probed at the UE.

The MSI-RS is transmitted periodically. The periodicity of the MSI-RS transmission is configured based on the set of available periods which is adjusted to the UE type or mode of the operation as well as the channel statistics. In at least one embodiment the period of the pilot signal is set based on the SAR operation period, e.g., 40 ms, by which the mismatch in the UL and DL is caused. This way the overhead of MSI-RS is notably reduced. In general, the MSI-RS is transmitted sparsely over time since the mismatch is notably robust over the time.

The MSI-RS is also transmitted sparsely over the frequency since the mismatch is notably robust over the frequency. For example, the MSI-RS is transmitted in a small bandwidth, e.g., several resource blocks (RBs), within the bandwidth configured for DL transmission. In another example, the MSI-RS is transmitted in a wide bandwidth with frequency density less than 1 subcarrier per RB, which is similar to the frequency resource defined for phase tracking reference signal (PT-RS) in 3GPP 5G. The frequency periodicity of the MSI-RS is also determined based on the bandwidth of the mismatch coherence; i.e. the bandwidth over which the mismatch properties remains virtually unchanged. In this way the overhead in the frequency domain is reduced to the bandwidth of the mismatch coherence.

In practice, the mismatch coefficients due to the circuitry at the gNB are accounted for such that the corresponding mismatch coefficients at the gNB antennas are assumed to be one, i.e. the gNB is calibrated before the gNB is connected to the radio access network (RAN), and therefore an assumption is able to be made that there is no mismatch. This makes the DL channel corresponding to different antennas at the gNB to be similarly affected by the mismatch coefficient at the UE. Therefore, to probe the mismatch at the UE, the MSI-RS is transmitted sparsely over the space, i.e. the antennas at the gNB. A subset of antennas at the gNB is able to be used for MSI-RS transmission. That is, the gNB selects only a subset of the antenna elements or antenna ports for the transmission of the MSI-RS. By doing this the overhead of MSI-RS is kept negligible in space in addition to the time and frequency dimensions

In another example, the MSI-RS is formed by using Channel State Information Reference Signal (CSI-RS) to reuse the existing reference signals (RS) of the state-of-art air interface. In yet another example, the MSI-RS is formed by using Synchronization Signal Block (SSB) to again reuse the existing signals of the state-of-art air interface in 3GPP.

### Step II in FIG. 7

The UE receives the DL pilots 510 from the gNB in Step II. Based on the received DL pilots (a.k.a. RS) with N′≤N antenna ports, where N is the maximum number of antenna ports, the UE performs a channel estimation for each receive antenna port 120a, 120b, . . . , 120n of the UE. In response to N′=N, the estimated DL channel is denoted as

$${H}_{DL} = [ \begin{matrix}\begin{matrix}\begin{matrix}{h}_{1} \\ {h}_{2}\end{matrix} \\ ⋮\end{matrix} \\ {h}_{K}\end{matrix} ] = [ \begin{matrix}{h}_{11} & {h}_{12} & … & {h}_{1 N} \\ {h}_{21} & {h}_{22} & ⋱ & ⋮ \\ ⋮ & ⋱ & ⋱ & {h}_{K - 1 , N} \\ {h}_{K 1} & … & {h}_{K , N - 1} & {h}_{KN}\end{matrix} ] , \qquad ( 3 )$$

where hᵢ=hᵢ_{₁} . . . hᵢ_{_{N}}] is the channel between the gNB antennas and the i-th antenna at the UE with the size 1×N where N is the number of antenna ports at the gNB and h_{l,k} is the channel between antenna l at the gNB and antenna k at the UE. Each antenna k at the UE corresponds to an UL RS antenna port, which will be introduced in Step IV of FIG. 7. In response to N′<N, the N in Eq. (3) is replaced by N′. In this example, N′=N. Here for the illustration purpose a perfect channel estimation is assumed. The case with a noisy channel estimation, for example in response to the estimate being written as H_{DL}+e where e is the estimation error, is treated similarly throughout.

In response to the DL RS transmitted from one transmission antenna port being mapped on multiple resource elements, the channel in Eq. (3) is determined based on measurements on all or a subset of the multiple resource elements.

Step III of FIG. 7 introduces that only a measure based on the power of hᵢ is used to determine the feedback information. Thus, the UE measures the power of hᵢ, i.e., |hᵢ|², instead of the full channel in Eq. (3). Note that for the actual power the value of |hᵢ|² is able to scale in response to being necessary, but sometimes this value is simply referred to as the power. Alternatively, the UE measures the power of received DL RS instead of power of channel because the power of transmitted DL RS is fixed and known at the gNB. Alternatively, the gNB obtains |hᵢ|² from the power of received DL RS corresponds to the i-th UL RS antenna port.

If the relation between UL-DL mismatch properties of antennas correspond to a subset of UL RS antenna ports are known or are assumed as known at the gNB, e.g., the same UL-DL mismatch properties in a subset, the UE measures |hᵢ|² for only one i antenna port in the subset of antenna ports.

Hence, the client device 100 in examples of embodiments described herein determine the downlink measurement information for the set of antenna ports 120a, 120b, . . . , 120n for each subset of antenna ports in the set of antenna ports 120a, 120b, . . . , 120n of the client device. Each subset of antenna ports in the set of antenna ports 120a, 120b, . . . , 120n includes at least one antenna port, i.e. one or more antenna ports.

In examples of embodiments described herein, the set of antenna ports 120a, 120b, . . . , 120n is further grouped into subsets of antenna ports based on at least one of the following: an antenna switching pattern of the set of antenna ports 120a, 120b, . . . , 120n associated with the transmission of the uplink reference signals 520; and mismatch properties between different antenna ports in the set of antenna ports 120a, 120b, . . . , 120n.

### Step III in FIG. 7

The UE based on the estimated DL channel H_{DL} determines or constructs a feedback signal. The purpose of the feedback signal is to assist the gNB to adjust the UL channel estimation which for example is found by using SRS transmitted from the UE.

To feedback the channel estimate, the UE could transmit the entire estimated channel. However, the overhead of such strategy is very high for large-scale Multiple-Input Multiple-Output (MIMO) system and is practically challenging. Hence, a very low-overhead feedback construction method according to at least one embodiment is described such that the gNB is still able to form its precoder as there were no mismatch between the UL and DL channels. The disclosed feedback schemes are based on measuring and sending back to the gNB the second order statistics and in particular total received power at each of K receiving antennas at the UE.

To motivate this choice of feedback strategy, consider the estimated UL channel at gNB which, based on the mathematical model of R1 and R2, is written as

$${H}_{U L}^{T} = [ \begin{matrix}{\overline{h}}_{1} \\ {\overline{h}}_{2} \\ ⋮ \\ {\overline{h}}_{K}\end{matrix} ] = [ \begin{matrix}\begin{matrix}\begin{matrix}{α}_{1} {β}_{1} {e}^{j {θ}_{1}} {h}_{1} \\ {α}_{2} {β}_{2} {e}^{j {θ}_{2}} {h}_{2}\end{matrix} \\ ⋮\end{matrix} \\ {α}_{K} {β}_{K} {e}^{j {θ}_{M}} {h}_{K}\end{matrix} ] \qquad ( 3 a )$$

Therefore, the amplitude of mismatch factor on UE antenna r is written as

αᵣβᵣ=|h̅ᵣ|²/|hᵣ|² (3b)

That is, the mismatch amplitude is related to the power of the DL and UL channels.

Another component of the present solution is the usage of the above feedback principle to determine the DL MIMO precoding matrix as in response to there being no mismatch between the measured UL channel and anticipated DL channel, as will be described in Step VII. In particular, as will be illustrated in the following, the downlink precoders based on correlation matrix of H_{DL} is oblivious to the phase of the mismatch factors. Therefore, the feedback is reduced to let the gNB know the amplitude of the mismatch factor. Since the quantity |h̅₁|² is obtained at the gNB by uplink channel estimation, the UE is able to only feedback the information of |hᵣ|² for each receive antenna to the gNB.

Therefore, in examples of embodiments described herein, the downlink measurement information indicates second order statistics of a downlink channel estimation. The second order statistics of the downlink channel estimation include at least one of: a downlink channel correlation matrix, a squared Euclidean norm of the downlink channel estimation, and a squared Euclidean norm of the downlink channel estimation scaled with a scaling factor.

However, in further examples of embodiments described herein, the downlink measurement information indicates a downlink received power at the set of antenna ports 120a, 120b, . . . , 120n of the client device 100.

In the sequel, multiple implementations of the above feedback design/principle will herein be disclosed.

### Analog Feedback Design

In the first implementation, the Feedback Signal (FS) is formed as the squared Euclidian norm of the channel measured at each receive antenna at the UE according to:

$${x}_{F S} = g [ \begin{matrix}\begin{matrix}\begin{matrix}{\vert {h}_{1} \vert}^{2} \\ {\vert {h}_{2} \vert}^{2}\end{matrix} \\ ⋮\end{matrix} \\ {\vert {h}_{K} \vert}^{2}\end{matrix} ] , \qquad ( 4 )$$

That is, the UE reports the value |hᵢ|² (i.e. g=1) or its scaled value g|hᵢ|² (i.e. g≠1) for 1≤i≤K, where g could be for example a power scaling factor. The power scaling is able to be used to satisfy the power transmission constraint at the UE.

We highlight that this feedback construction reduces the radio channel space compromising of 2NK real dimensions in Eq. (3) to K positive real dimensions in Eq. (4) because the UE only sends feedback indication of mismatch factors compromising of K real numbers each associated to K UE antennas to gNb according to Eq. (4). In practical systems, the number of antennas at the UE is much smaller than those at the base station. That is K«N, which results to a notable dimension reduction and hence this strategy enables a significant feedback overhead reduction. For example, for gNB with N=128 antennas and the UE K=2 antennas, the number of total real dimensions reduces from 512 real dimensions to 2 positive real dimensions.

The feedback design construction in Eq. (4) is motivated based on the precoder that will discussed in Step VII. That is, the design is suitable for the practical precoder in Step VII as well as enjoying a low feedback overhead.

Asymptotic Analog Feedback Design

In the next implementation, the UE employs a particular scaling factor in Eq. (4), for which the disclosed feedback strategy statically converges as the number of antennas at the base station increases. In the following, consider the normalized feedback signal where the normalization factor is set to g=1/N where N is the number of transmit antennas at the gNB. This yields,

$${x}_{As , FS} = \frac{1}{N} {x}_{FS} = \frac{1}{N} [ \begin{matrix}\begin{matrix}\begin{matrix}{\vert {h}_{1} \vert}^{2} \\ {\vert {h}_{2} \vert}^{2}\end{matrix} \\ ⋮\end{matrix} \\ {\vert {h}_{K} \vert}^{2}\end{matrix} ] = [ \begin{matrix}\begin{matrix}\begin{matrix}\frac{{\sum }_{i = 1}^{N} {\vert {h}_{1 i} \vert}^{2}}{N} \\ \frac{{\sum }_{i = 1}^{N} {\vert {h}_{2 i} \vert}^{2}}{N}\end{matrix} \\ ⋮\end{matrix} \\ \frac{{\sum }_{i = 1}^{N} {\vert {h}_{Ki} \vert}^{2}}{N}\end{matrix} ] \qquad ( 5 )$$

$${\to }^{as N \to ∞} [ \begin{matrix}\begin{matrix}\begin{matrix}{\vert {h}_{1 i} \vert}^{2} \\ {\vert {h}_{2 i} \vert}^{2}\end{matrix} \\ ⋮\end{matrix} \\ {\vert {h}_{Ki} \vert}^{2}\end{matrix} ]$$

where the last equation follows for some classes of channels including in response to the channel components being independent and identically distributed (i.i.d.). Hence for large number of antennas N»1, the UE reports the mean values of the measured channels. That is, the UE tracks the mean values of the squared Euclidean norm observed at each receive antennas and reports that or the deviations from the mean value. Additional power scaling factors are also applied.

Digital Feedback Design

In some practical systems, converting the analog feedback signal x_{FS} to a digital signal is beneficial. We next discuss how a digital feedback signal is generated from the disclosed analog counterpart x_{FS}. The general quantization approach is written as

x_{q,FS}=Q(x_{FS}) (6)

where Q(·) denotes a quantization function and x_{q,FS} is the quantized Feedback Signal (cf. q, SF) vector. We next discuss an implementation of Eq. (6).

In the following let B be the total number of quantization bits per dimension. That is the total number of quantization bits is KB where K the number of antennas at the UE is. The following table shows an implementation of the quantization codebook for B bits in response to the number of quantization indices being equal to 2^{B}.

TABLE I
An example of quantization mapping

| | | Quantized |
|---|---|---|
| Quantization | Quantization | Real |
| Index | Bit-Mapping | Value |
| 1 | 00 . . . 00 | μₖ + Δ_{k, 1} |
| 2 | 00 . . . 01 | μₖ + Δ_{k, 2} |
| . | . | . |
| . | . | . |
| . | . | . |
| i | . | μₖ + Δ_{k, i} |
| | . | |
| | . | |
| . | . | . |
| . | . | . |
| . | . | . |
| 2^{B} | 11 . . . 11 | μₖ + Δ_{k, 2}^{B} |

The quantized value for index i, 1≤i≤2^{B} and antenna k, 1≤k≤K at the UE is given by

$${x}_{i , k , q , FS} = {Q}_{k , i} ( {\vert {h}_{k} \vert}^{2} ) = {μ}_{k} + {Δ}_{k , i} \qquad ( 7 )$$

For each antenna port, the quantization mapping is described by 2^{B}+1 parameters including μₖ, Δ_{k,1}, Δ_{k,2}, . . . , Δ_{k,2}_{^{B}} where parameter μₖ is understood as either the mean or an initialization and the Δ_{k,i}, as the step-size or the deviations.

Generally, the digital feedback signal is obtained based on a uniform or a non-uniform quantizer in which a quantization region or a corresponding mapping of the uniform or the non-uniform quantizer is configured based on at least one of: specific absorption ratio control, and

hardware mismatch properties between different antenna ports of the set of antenna ports 120a, 120b, . . . , 120n of the client device 100.

### Uniform Quantization

In an example of at least one embodiment, uniform quantization is able to be used by selecting Δ_{k,i}=Δ_{k,j} for i,j. One way is to select the range of variable for which most the realization happens and then divide that range into 2^{B} intervals. Let Ω be the range of realization that have the probability close to one. Then a selection of μ_k=0 is made and

$${Δ}_{k , i} = ( 2 i - 1 ) \frac{Ω}{{2}^{B + 1}} \qquad ( 8 )$$

Note that the variable Ω in Eq. (8) is able to be optimized depending on the channel statistics including the mismatch properties or the design scenario at hand.

### Non-Uniform Quantization

In another example of at least one embodiment, non-uniform quantization is able to be used by selecting unequal values for Δ_{k,i} for i,j. Let Ω be the range of realization that have the probability close to one. Then μ_k=0 is selected and

$${Δ}_{k , i} = \frac{Ω}{\sqrt{{2}^{{2}^{B} - i}}} \qquad ( 9 )$$

The variable Ω is again optimized depending on the channel statistics including the mismatch properties or the design scenario at hand.

### Asymptotic Digital Feedback Design

In yet another implantation, the asymptotic behavior for large number of antennas is used. Next consider the normalized feedback signal prior to the quantization as

$$\begin{matrix}{x}_{q , FS} = ( \frac{1}{N} {x}_{FS} ) \\ = ( \frac{1}{N} [ \begin{matrix}{\vert {h}_{1} \vert}^{2} \\ {\vert {h}_{2} \vert}^{2} \\ ⋮ \\ {\vert {h}_{K} \vert}^{2}\end{matrix} ] \\ = ( [ \begin{matrix}\frac{{\sum }_{i = 1}^{N} {\vert {h}_{1 i} \vert}^{2}}{N} \\ \frac{{\sum }_{i = 1}^{N} {\vert {h}_{2 i} \vert}^{2}}{N} \\ ⋮ \\ \frac{{\sum }_{i = 1}^{N} {\vert {h}_{Ki} \vert}^{2}}{N}\end{matrix} ] ) \\ {⟶}^{as N \to ∞} ( [ \begin{matrix}{\vert {h}_{1 i} \vert}^{2} \\ {\vert {h}_{2 i} \vert}^{2} \\ ⋮ \\ {\vert {h}_{Ki} \vert}^{2}\end{matrix} ] )\end{matrix} \qquad ( 10 )$$

where the last equation similarly follows by assuming that the channel components are i.i.d. Hence for large N, the quantization index associated to the mean values are quantized and reported. That is, the UE tracks the mean values of the squared Euclidian norms observed at the UE and reports the deviations from the mean value. That is,

$$\begin{matrix}{x}_{i , k , q , FS} = {Q}_{k , i} ( {\vert {h}_{k} \vert}^{2} ) \\ = {μ}_{k} + {Δ}_{k , i}\end{matrix} \qquad ( 11 )$$

where μₖ= [symbol] |hₖᵢ|² and Δ_{k,i} is chosen based the variance around the mean value, which could be found based on the channel statistics.

Some other variations augment all previous implementations.

### Differential Feedback Design

This implementation uses a differential feedback. That is the UE reports the change in the measurement with respect to the previous feedback value(s). The reported change further is transmitted in analog or quantized fashions as those in the previous cases. For example, in response to the power of the i-th antenna port at UE being |hᵢ|² and |h̅ᵢ|² for current and previous measurement, the change is determined by |hᵢ|²/|h̅ᵢ|² or |hᵢ|²−|h̅ᵢ|². In other words, in examples of embodiments described herein, the feedback signal 530 indicates the downlink measurement information as an incremental change of downlink measurement information compared to previous downlink measurement information.

### Relative Feedback Design

In this implementation, the measurements are arranged in a new vector with one size smaller than the total number of antenna ports at the UE and then all previous implementations are applied to this new vector. In this way the overhead is further reduced. Assuming that the first antenna ports as reference antenna ports such that the measurements for example for the quantized feedback are performed as

$$( \frac{1}{N} [ \begin{matrix}{\vert {h}_{2} \vert}^{2} / {\vert {h}_{1} \vert}^{2} \\ {\vert {h}_{3} \vert}^{2} / {\vert {h}_{1} \vert}^{2} \\ ⋮ \\ {\vert {h}_{K} \vert}^{2} / {\vert {h}_{1} \vert}^{2}\end{matrix} ] ) .$$

Thus, the feedback overhead is reduced to (K−1)B, which is significant for small numbers of antenna ports at the UE. The reference antenna ports are any pre-determined antenna ports in examples. In other words, in examples of embodiments described herein the feedback signal 530 indicates the downlink measurement information as an incremental change of downlink measurement information for different antenna ports or subsets of antenna ports compared to other antenna ports or other subsets of antenna ports.

### Multi-Carrier Feedback Design

For the case of multicarrier transmission for example as that in OFDM waveform, the mismatch coefficients tend to be robust over the frequency. In response to this being the case, the UE reports one feedback signal for all subcarriers. For example, the UE averages out all measurements, e.g., channel, Euclidian norm of channel or squared Euclidian norm of channel, over different subcarriers and then apply any previous implementation on the average value.

In cases the mismatch characteristics change in the frequency, the UE chooses a feedback granularity in the frequency that is suitable to a particular mismatch model. For example, in response to the feedback granularity being M RBs and the total bandwidth is N RBs, the UE reports N/M or ┌N/M┐ feedback signals for every M RBs (one of these feedback signal corresponds to N−└N/M┘M RBs in response to N not being a multiple of M). For example, for M=10 and N=25, the UE reports 3 feedback signals, which correspond to (RB1 to RB10), (RB11 to RB20) and (RB21 to RB25), respectively. The last signal corresponds to 5=25−└25/10┘*10 RBs in this example. Note that the order of feedback is different from RB order. Each feedback signal is generated for M RBs as in the previous case. In an example, the value of M is equal to the precoding resource block group (PRG) size for downlink, and therefore one downlink precoding is determined based on one feedback signal.

Therefore, in examples of embodiments described herein, the downlink measurement information for the set of antenna ports 120a, 120b, . . . , 120n is for each downlink frequency band carrying the set of downlink reference signals 510.

In the implementation examples above, the quantity |hᵢ|² is replaced by the sum power of received signals on the i-th receiver antenna port, which is equivalent to scaled value of |hᵢ|² in response to the power of the DL pilot signals being the same for different antenna ports. In response to the power of the DL pilot signals being different for different antenna ports and the power ratio between them being known, the |hᵢ|² is replaced by the sum power of received signals divided by their ratios, respectively.

In the implementation examples above, in response to the relation between UL-DL mismatch properties of antennas that correspond to a subset of UL RS antenna ports being known (or being assumed as known) at the gNB, e.g., the same UL-DL mismatch properties in a subset, the UE reports measurement information based on |hᵢ|² for only one i in the subset. For example, the UL RS is SRS, the set of UL RS antenna ports are divided into several subsets. The UL RS antenna ports belong to the same subset are included in the same SRS resource, and all the SRS resources are included in one or more SRS resource sets with usage “antenna switching” or “DL CSI acquisition”. In this case, the UL-DL mismatch properties correspond to UL RS antenna ports in the same subset are assumed as the same, and thus the UE only reports based on |hᵢ|² for only one i in the subset.

### Step IV in FIG. 7

The gNB receives the feedback signal 530 containing indications of |hᵢ|² (Cf. x_{FS} and x_{q,FS}). The next steps reveal that the importance of this choice and how DL transmission is solved in response to the UL and DL channels being mismatched.

### Step V and VI in FIG. 7

The UE transmits conventional UL SRS as a set of UL reference signals 520 and by the help of which the gNB estimates the UL channel under the mismatch. That is, a channel vector which gives the mismatched DL channel. For example, at this stage the UE has activated its SAR control operation and hence there will be a mismatch between the UL and DL. The mismatched DL channel based on the UL measurement is represented as

$${H}_{UL}^{T} = [ \begin{matrix}{\overline{h}}_{1} \\ {\overline{h}}_{2} \\ ⋮ \\ {\overline{h}}_{K}\end{matrix} ] = [ \begin{matrix}{α}_{1} {β}_{1} {e}^{j {θ}_{1}} {h}_{1} \\ {α}_{2} {β}_{2} {e}^{j {θ}_{2}} {h}_{2} \\ ⋮ \\ {α}_{K} {β}_{K} {e}^{j {θ}_{M}} {h}_{K}\end{matrix} ] \qquad ( 12 )$$

where h̅ᵢ is the mismatched channel and hᵢ is the actual DL channel. The parameters αᵢ, βᵢ∈(0,1], θᵢ∈[−π, π] are used to model the mismatch parameters at the UE. We further assume that the mismatch at the gNB is normalized to one and only consider the equivalent mismatch at the UE. Thus, the measured UL channel at gNB using UL SRS is therefore written as

$${\underbrace{{H}_{UL}}}_{\begin{matrix}Mismached UL \\ Channel\end{matrix}} = {\underbrace{Diag ( {α}_{1} {β}_{1} {e}^{j {θ}_{1}} , … , {α}_{K} {β}_{K} {e}^{j {θ}_{K}} )}}_{\begin{matrix}Parametrized Mismatch \\ Matrix\end{matrix}} {\underbrace{{H}_{DL}}}_{\begin{matrix}Actual DL \\ Channel\end{matrix}} \qquad ( 13 )$$

From Eq. (13) the DL channel HDL is written as

H_{DL}=Diag(α₁⁻¹β₁⁻¹e^{-jθ}^{₁}, . . . ,α_{K}⁻¹β_{K}⁻¹e^{-jθ}^{_{K}})H_{UL} (13a)

To compute H_{DL}, the phase values θᵢ are used but these values are not available as they are not contained in the feedback information. However, in Step VII the gNB still obtains one of key practical precoders without the knowledge of θᵢ.

Step V and VI are performed at any order prior to Step VII.

### Step VII in FIG. 7

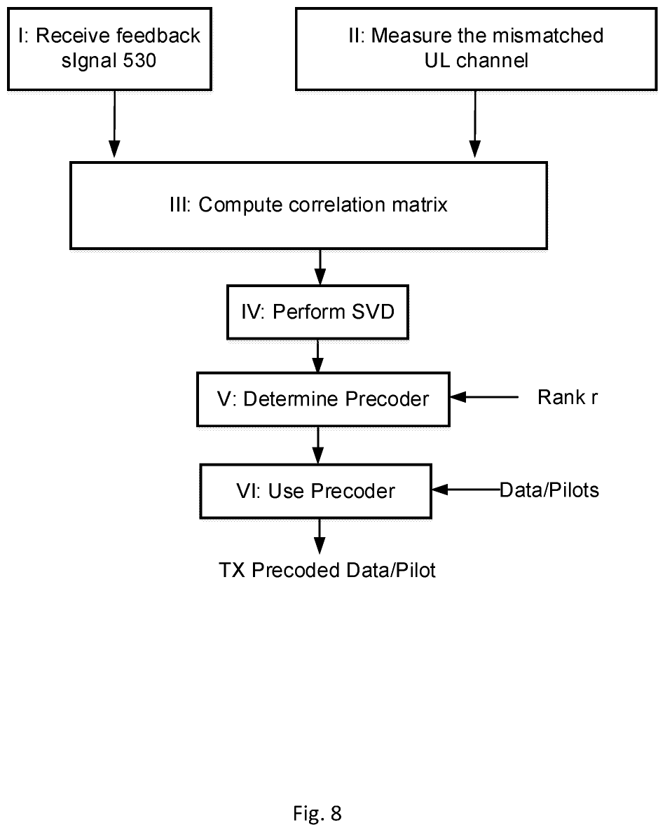

In Step VII the precoder is computed by the gNB which will be described in detail with reference to FIG. 8.

FIG. 8 shows a flow chart of a method to generate an enhanced precoder design in the gNB based on the received feedback signal and the measured mismatched UL channel.

In step I in FIG. 8, the gNB receives a feedback signal 530 transmitted from the UE.

In step II in FIG. 8, the gNB measures the mismatched UL channel from the UE to the gNB to obtain a measured UL channel based on the set of UL reference signals 520 transmitted by the UE as previously explained.

In step III in FIG. 8, the gNB computes a correlation matrix. One of the precoders that is used in practical applications is based on a correlation matrix. Hence, computing the correlation matrix of the actual DL channel is important in response to the impact of mismatched being accounted for using the feedback signal 530 and the measured UL channel via reception of the UL SRS at the gNB.

To compute a correct correlation matrix the gNB uses the actual DL channel which is H_{DL}. However, the matrix HDL is not known to the gNB and only its mismatched version, i.e. H_{UL} is available at the gNB (cf. Eq. (13)). In the following, how the gNB computes the correct DL correlation matrix is outlined. Consider the sample correlation matrix which is written as

$$\begin{matrix}{R}_{DL} {=}^{def} {H}_{DL}^{H} {H}_{DL} = {H}_{UL}^{H} [ \begin{matrix}{α}_{1}^{- 2} {β}_{1}^{- 2} & 0 & … & 0 \\ 0 & {α}_{2}^{- 2} {β}_{2}^{- 2} & ⋱ & ⋮ \\ ⋮ & ⋱ & ⋱ & 0 \\ 0 & … & 0 & {α}_{K}^{- 2} {β}_{K}^{- 2}\end{matrix} ] {H}_{UL} \\ = {H}_{UL}^{H} diag ( {α}_{1}^{- 2} {β}_{1}^{- 2} , … , {α}_{K}^{- 2} {β}_{K}^{- 2} ) {H}_{UL}\end{matrix} \qquad ( 14 )$$

where the 2^{nd} equality follows by using Eq. (13a). The size of the matrix H_{DL} in Eq. (14) is K×N, where N and K are numbers of antennas at gNB and UE, respectively, as previously mentioned. Thus, the size of the correlation matrix R_{DL} is N×N. By using this representation, the equality in Eq. (14) is rewritten using only the received feedback signal 530 from the UE (i.e. step I) and the measured UL channel (i.e. step II) found using SRS according to

$$\begin{matrix}{R}_{DL} = {H}_{UL}^{H} diag ( \frac{{\vert {h}_{DL , 1} \vert}^{2}}{{\vert {h}_{UL , 1} \vert}^{2}} , … , \frac{{\vert {h}_{DL , K} \vert}^{2}}{{\vert {h}_{UL , K} \vert}^{2}} ) {H}_{UL} \\ = {H}_{UL}^{H} diag ( \frac{{x}_{FS , 1}}{{\vert {h}_{UL , 1} \vert}^{2}} , … , \frac{{x}_{FS , K}}{{\vert {h}_{UL , K} \vert}^{2}} ) {H}_{UL} \\ = {H}_{UL}^{H} diag ( \frac{{x}_{FS , 1}}{{\vert {h}_{UL , 1} \vert}^{2}} , … , \frac{{x}_{FS , K}}{{\vert {h}_{UL , K} \vert}^{2}} ) {H}_{UL}\end{matrix} \qquad ( 15 )$$

where the last equality follows by the definition of the feedback signal based on the Euclidian norm.

Having found the correct correlation matrix, the gNB determines the precoder based on the eigenvectors of the correlation matrix given in Eq. (15).

In step IV in FIG. 8, the gNB therefore performs SVD. Let the SVD decomposition of the correlation matrix is

$${R}_{DL} = {[ {e}_{1} , {e}_{2} , … , {e}_{K} ] [ \begin{matrix}{σ}_{1} & 0 & … & 0 \\ 0 & {σ}_{2} & ⋱ & ⋮ \\ ⋮ & ⋱ & ⋱ & 0 \\ 0 & … & 0 & {σ}_{K}\end{matrix} ] [ {e}_{1} , {e}_{2} , … , {e}_{K} ]}^{H} \qquad ( 16 )$$

where eᵢ, i=1, . . . , K are the eigenvectors with the size is N×1, and σᵢ, i=1, . . . , K are the corresponding eigenvalues which without loss of the generality are arranged in a descending order. In response to the rank of downlink transmission being set to r (r≤K) as shown in FIG. 8, the gNB in step V in FIG. 8 determines the precoder of size N×R by selecting the first R eigenvalues according to

P_{R}=[e₁,e₂, . . . ,eᵣ] (17)

Note that x_{FS} is generated using any implementation form discussed in Step III in FIG. 7.

In response to the scaling factor g being used, the correlation matrix is modified as

$$\begin{matrix}{gR}_{DL} = {gH}_{DL}^{H} {H}_{DL} \\ = {H}_{UL}^{H} diag ( g \frac{{x}_{FS , 1}}{{\vert {h}_{UL , 1} \vert}^{2}} , … , g \frac{{x}_{FS , K}}{{\vert {h}_{UL , K} \vert}^{2}} ) {H}_{UL}\end{matrix} \qquad ( 18 )$$

For multi-user transmission, the difference in scaling factor g between different UEs is estimated by letting the UE report Reference Signal Received Power (RSRP) measured based on the received MSI-RS or its implementation, e.g. via CSI-RS.

In step VI in FIG. 8, the gNB based on the determined precoder encodes data and/or pilots for DL MIMO transmission to the UE.

Finally, the gNB performs a DL MIMO transmission of data and/or pilots to the UE.

### Performance Evaluation

At least one embodiment addresses the UL-DL mismatch problem with a very low feedback overhead. This section illustrates this advantage of at least one embodiment by looking at DL transmission from a gNB with 32T32R to UE with 2T4R, and N=32 and K=4 in a simulation. Moreover, the configuration 2T4R means that there are two RF transmission chains at the UE side, and the UE has to transmit SRS twice to enable gNB estimate the uplink channel, i.e., the UE transmits SRS on the first two of its 4 antennas at the first time and transmits SRS on the rest two of its 4 antenna at the second time. The mismatch factors are different for the first two antennas and the second two antennas. Thus, the mismatch factors for 4 antenna ports are modelled as k[1,1, αβe^{jθ}, αβe^{jθ}], where the parameter k is a common factor and k=1 is normalized in the simulation. The mismatched parameters are set such that β=−5 dB, θ=π/3, and α∈[−3,−2]dB are randomly and uniformly selected in every ms in the simulations. This model is a special class of the general model is used because SRS antenna switching usually causes significant UL-DL channel mismatch difference because:
The cabling difference between two groups of antennas ports causes much larger hardware mismatch between the two groups; and
Since the two groups of SRS are transmitted in different time, the power mask of SAR is quite different.

Comparing with mismatch difference between the two groups of SRS, the difference within each SRS antenna group is usually small. These ranges of the mismatch parameters are motivated by some practical measurements. The channel model is assumed to be CDL-C with bandwidth of 10 Resource Blocks (RBs) which is equal to 120 subcarriers.

The following detailed steps are used i′ the evaluation according to embodiments described herein:
Step 1: A gNB transmits MSI-RS to a UE on antenna port 1,
Step 2: The UE estimates the downlink channel between the first gNb antenna port (N′=1) and K=4 UE antenna port as

$${H}_{DL} = [ \begin{matrix}{h}_{11} \\ {h}_{21} \\ {h}_{31} \\ {h}_{41}\end{matrix} ]$$

where hₖ₁ k=1,2,3,4 is the channel between the first gNb antenna port and the k-th UE antenna averaged on all Res of the MSI-RS.
Step 3: The UE feedbacks the indications of the mismatch factors to the gNB. Consider 3 different feedback methods:
Disclosed solution with the analog feedback: UE sends the feedback x_{FS}=

$$g [ \begin{matrix}{\vert {h}_{11} \vert}^{2} \\ {\vert {h}_{21} \vert}^{2} \\ {\vert {h}_{31} \vert}^{2} \\ {\vert {h}_{41} \vert}^{2}\end{matrix} ] ,$$

where the power scaling factor is set to g=1.
Disclosed solution with uniform digital feedback of 5 bits: the UE sends the feedback

$${Q}_{un} ( {x}_{FS} ) = g [ \begin{matrix}{Q}_{un} ( {\vert {h}_{11} \vert}^{2} ) \\ {Q}_{un} ( {\vert {h}_{21} \vert}^{2} ) \\ {Q}_{un} ( {\vert {h}_{31} \vert}^{2} ) \\ {Q}_{un} ( {\vert {h}_{41} \vert}^{2} )\end{matrix} ]$$

where Qᵤₙ(·) is a uniform quantization operation according to Eq. (8). In this simulation, each |hₖ₁|² is quantized into bits uniformly and the quantization range is computed for the value of 90% of the channel realization. That is, only 5 bits for each UE's antenna port is fed back to the gNB. Feedback g=1 is set.
Disclosed solution with non-uniform digital feedback of 5 bits: UE feedback

$${Q}_{non - un} ( {x}_{FS} ) = g [ \begin{matrix}{Q}_{non - un} ( {\vert {h}_{11} \vert}^{2} ) \\ {Q}_{non - un} ( {\vert {h}_{21} \vert}^{2} ) \\ {Q}_{non - un} ( {\vert {h}_{31} \vert}^{2} ) \\ {Q}_{non - un} ( {\vert {h}_{41} \vert}^{2} )\end{matrix} ]$$

where Qₙₒₙ₋ᵤₙ(·) is non-uniform quantization operation according to Eq. (9). In this simulation, each |hk₁|² is also quantized into 5 bits non-uniformly and the quantization range is computed for the value of 90% of the channel realization. We set g=1.

Step 4: The gNB receives the feedback signal from the UE in step 3.

Step 5 & 6: The UE transmits SRS and the gNB estimates the uplink channel based on the received SRS. The estimated uplink channel is expressed as

$${H}_{UL} = [ \begin{matrix}{\overline{h}}_{11} & {\overline{h}}_{12} & … & {\overline{h}}_{1 , 32} \\ {\overline{h}}_{21} & {\overline{h}}_{22} & ⋱ & ⋮ \\ ⋮ & ⋱ & ⋱ & {\overline{h}}_{3 , 32} \\ {\overline{h}}_{41} & … & {\overline{h}}_{4 , 31} & {\overline{h}}_{4 , 32}\end{matrix} ] ,$$

Step 7: The gNB computes the correlation matrix based on H_{UL} and feedback information as

$${R}_{DL} = {H}_{UL}^{H} diag ( \frac{{x}_{FS , 1}}{{\vert {\overline{h}}_{11} \vert}^{2}} , \frac{{x}_{FS , 2}}{{\vert {\overline{h}}_{21} \vert}^{2}} , \frac{{x}_{FS , 3}}{{\vert {\overline{h}}_{31} \vert}^{2}} , \frac{{x}_{FS , 4}}{{\vert {\overline{h}}_{41} \vert}^{2}} ) {H}_{UL}$$

where x_{FS,k}, k=1,2,3,4 is the k-th mismatch factor obtained from the feedback of UE.

The gNB also determines the rank of the DL transmission, which is assumed to be r=2 in this simulation. Then, the gNB computes r=2 eigenvectors e₁, e₂ of R_{DL} correspond to the first 2 largest eigenvalues. Finally, the gNB determines the downlink precoder as

P=[e₁,e₂]

After all, the gNB transmits downlink data/pilot by using the precoder P.

We look at the block error rate (BLER) of NR low density parity check (LDPC) coded transmission of length 960 with different codes rate using 16QAM in response to two data streams in the DL being simultaneously transmitted.

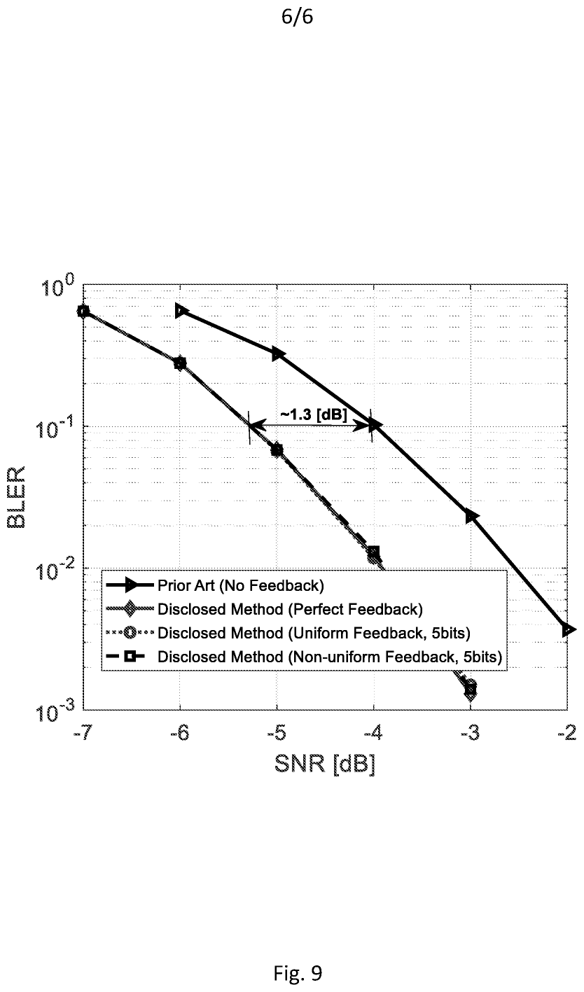

FIG. 9 depicts the BLER performance (y-axis) of LDPC-coded transmission for code rate ½ as a function of SNR in dB (x-axis) with two data streams for gNB of 32T32R and UE of 2T4R for four schemes: the prior art with no feedback, the disclosed solution with the perfect analog feedback, the disclosed solution with uniform digital feedback of 5 bits, and the disclosed solution with non-uniform digital feedback of 5 bits. The total spectral efficiency is 4 [bpcu].

From FIG. 9 embodiments described herein are observed to significantly improves on conventional solution/method and performance close to perfect analog feedback is obtained by having only 5 bits feedback. Particularly, for rate ½ and ⅔, the disclosed solution/method according to at least one embodiment is observed to provide close to 1.3 [dB] and for the code rate ¾, the disclosed solution/method according to at least one embodiment provides nearly 1.5 [dB] power gain at BLER of 10%.

Furthermore, any method according to at least one embodiment is implemented in a computer program, having code means, which in response to being run by processing means causes the processing means to execute the steps of the method. The computer program is included in a computer readable medium of a computer program product. The computer readable medium includes essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, the skilled person realizes that examples of the client device 100 and the network access node 300 includes the communication capabilities in the form of e.g., functions, means, units, elements, etc., for performing the solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Especially, the processor(s) of the client device 100 and the network access node 300 includes, e.g., one or more instances of a Central Processing Unit (CPU), a processing unit, a processing circuit, a processor, an Application Specific Integrated Circuit (ASIC), a microprocessor, or other processing logic that interprets and executes instructions. The expression “processor” thus represents a processing circuitry comprising a plurality of processing circuits, such as, e.g., any, some or all of the ones mentioned above. The processing circuitry further performs data processing functions for inputting, outputting, and processing of data comprising data buffering and device control functions, such as call processing control, user interface control, or the like.

Finally, embodiments described herein are understood to not be limited to the examples described above, but also relate to and incorporate all examples within the scope of the appended independent claims.

1. A client device for a communication system, the client device being configured to:
receive a set of downlink reference signals from a network access node;
determine downlink measurement information for a set of antenna ports of the client device based on the set of received downlink reference signals;
determine a feedback signal indicating the downlink measurement information;
transmit a set of uplink reference signals to the network access node via the set of antenna ports of the client device; and
transmit the feedback signal to the network access node (300).

2. The client device according to claim 1, further configured to determine the downlink measurement information for the set of antenna ports of the client device by:
determining downlink measurement information for each subset of antenna ports in the set of antenna ports of the client device, wherein each subset of antenna ports comprises at least one antenna port.

3. The client device according to claim 2, wherein the set of antenna ports of the client device are grouped into subsets of antenna ports based on at least one of
an antenna switching pattern of the set of antenna ports of the client device associated with the transmission of the uplink reference signals; or
mismatch properties between different antenna ports in the set of antenna ports.

4. The client device according to claim 1, further configured to determine the downlink measurement information for the set of antenna ports of the client device by:
determining downlink measurement information for each downlink frequency band carrying the set of downlink reference signals.

5. The client device according to claim 1, wherein the downlink measurement information indicates second order statistics of a downlink channel estimation, and wherein the second order statistics of the downlink channel estimation comprises at least one of:
a downlink channel correlation matrix,
a squared Euclidean norm of the downlink channel estimation, or
a squared Euclidean norm of the downlink channel estimation scaled with a scaling factor.

6. The client device according to claim 1, wherein the downlink measurement information indicates a downlink received power at the set of antenna ports of the client device.

7. The client device according to claim 1, wherein the feedback signal indicates the downlink measurement information as:
an incremental change of downlink measurement information compared to previous downlink measurement information; or
an incremental change of downlink measurement information for different antenna ports or subsets of antenna ports compared to other antenna ports or other subsets of antenna ports.

8. The client device according to claim 1, wherein the feedback signal is a digital feedback signal obtained based on an uniform or a non-uniform quantizer, wherein a quantization region or a corresponding mapping of the uniform or the non-uniform quantizer is configured based on at least one of:
specific absorption ratio control, or
hardware mismatch properties between different antenna ports of the set of antenna ports of the client device.

9. A network access node for a communication system, the network access node being configured to
transmit a set of downlink reference signals to a client device;
receive a set of uplink reference signals from the client device; and
receive a feedback signal from the client device, wherein the feedback signal indicates downlink measurement information for a set of antenna ports of the client device associated with the set of downlink reference signals.

10. The network access node according to claim 9, further configured to determine of the precoder by:
computing a correlation matrix based on the set of received uplink reference signals and the received feedback signal,
determining a precoder for the downlink transmission to the client device based on the computed correlation matrix, and
performing a downlink transmission to the client device based on the precoder.

11. The network access node according to claim 9, wherein the feedback signal indicates downlink measurement information for each subset of antenna ports in the set of antenna ports of the client device, wherein each subset of antenna ports comprises at least one antenna port.

12. The network access node according to claim 9, wherein the feedback signal indicates downlink measurement information for each downlink frequency band carrying the set of downlink reference signals.

13. The network access node according to claim 9, wherein the downlink measurement information indicates second order statistics of a downlink channel estimation, and wherein the second order statistics of the downlink channel estimation includes at least one of:
a downlink channel correlation matrix,
a squared Euclidean norm of the downlink channel estimation, or
a squared Euclidean norm of the downlink channel estimation scaled with a scaling factor.

14. The network access node according to claim 9, wherein the downlink measurement information indicates a downlink received power at the set of antenna ports of the client device.

15. The network access node according to claim 9, wherein the feedback signal indicates the downlink measurement information as:
an incremental change of downlink measurement information compared to previous downlink measurement information; or
an incremental change of downlink measurement information for different antenna ports or subsets of antenna ports compared to other antenna ports or other subsets of antenna ports.

16. The network access node according to claim 9, wherein the feedback signal is a digital feedback signal obtained based on an uniform or a non-uniform quantizer, wherein a quantization region or a corresponding mapping of the uniform or the non-uniform quantizer is configured based on at least one of:
specific absorption ratio control, or
hardware mismatch properties between different antenna ports of the set of antenna ports of the client device.

17. A method for a client device, comprising:
receiving a set of downlink reference signals from a network access node;
determining downlink measurement information for a set of antenna ports of the client device based on the set of received downlink reference signals;
determining a feedback signal indicating the downlink measurement information;
transmitting a set of uplink reference signals to the network access node via the set of antenna ports of the client device; and
transmitting the feedback signal to the network access node.

18. A method for a network access node, comprising:
transmitting a set of downlink reference signals to a client device;
receiving a set of uplink reference signals from the client device; and
receiving a feedback signal from the client device, wherein the feedback signal indicates downlink measurement information for a set of antenna ports of the client device associated with the set of downlink reference signals.
